(19) United States
(12) Patent Application Publication
(10) Pub. No.: US 2010/0080410 A1
(43) Pub. Date: Apr. 1, 2010

(54) METHOD AND SYSTEM FOR PREVENTING USE OF A PHOTOGRAPH IN DIGITAL SYSTEMS

(75) Inventors: LISA SEACAT DELUCA, SAN FRANCISCO, CA (US); TRAVIS M. GRIGSBY, AUSTIN, TX (US); STEVEN M. MILLER, CARY, NC (US); DANIEL D. MORRIS, ROUND ROCK, TX (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/240,641

(22) Filed: Sep. 29, 2008

(51) Int. Cl. G06K 9/00; G06F 21/00

(52) U.S. Cl. 382/100; 726/2

(57) ABSTRACT

A photograph processing system that prevents the unpermitted use of photographic media containing a depiction of a protected person, view or item. A permission object is located in physical proximity to the person, view or object being protected. A photograph including the permission object will contain a depiction of the permission object. When the photograph is processed, the photograph processing system scans the photograph for a permission object. If a permission object is found, the system further processes the photograph according to the permission associated with the permission object.

### BACKGROUND

The present invention relates to the field of electronic privacy, and more particularly to controlling use of photographic media taken or copied by third parties without consent of a person or owner of an item shown in a photograph.

Digital media has given rise to privacy concerns in recent years due to the ease with which digitized media can be reproduced and transmitted. More recently additional concerns have arisen due to so called “social networking” and other media content hosting websites. There have been incidents where individuals have been denied employment, or removed from employment upon an employer discovering images of the employee or job candidate on the internet. In some cases such images may have been published without permission of a person shown in the picture.

Another area of concern regarding privacy and the internet is the transmission and reproduction of published images. For example, a person may place a personal photograph on a “private” image hosting web page which is accessible to friends and family members. However, any one of such friends and family members may innocently copy and transmit the image to a third party who may place the picture in a public internet location. The picture may then be further reproduced and placed on other web sites, or the picture may be altered by others to the embarrassment of the owner of the picture and published on the internet. Accordingly, there is a need to provide some measure of image security to prevent copying and use by others in ways unintended by the owner of the picture.

### BRIEF SUMMARY

The invention provides in one embodiment a method of controlling use of photographic media, which commences upon receiving a photograph file at a photograph processing system. The photograph processing system may include any system which handles photographic media, such as digital cameras, media hosting websites, and photo editing software applications, among others. Upon receiving a photograph file the photograph processing system commences scanning the photograph file for a permission object depiction in the photograph. The permission object is visible in the photograph file when the photograph file is visually rendered. Upon detecting the permission object in the photograph file the photograph processing system commences determining a permission corresponding to the permission object. The permission indicates whether further processing of the photograph file is permitted.

Another embodiment of the invention provides a method of processing photographic media depicting a permission object. The method commences by scanning a photograph file for a permission object depiction, which is the result of a permission object being in a field of view of the photograph file. Upon detecting the permission object depiction in the photograph file, the method then commences determining a permission corresponding to the permission object, and processing the photograph file according to the permission corresponding to the permission object.

In another embodiment of the invention the invention provides a computer program product for photographic image processing, which includes a machine readable storage medium containing machine code stored in the machine readable storage medium which when executed by a photograph image processing system configures the photograph image processing system to scan a photograph file for a permission object depiction. The permission object depiction is the result of a permission object being in a field of view of the photograph file. The photograph image processing system is further configured to detect the permission object depiction in the photograph file and then determine a permission corresponding to the permission object. Once the permission information has been determined, the photograph image processing system is configured to process the photograph file according to the permission information.

### BRIEF DESCRIPTION OF THE SEVERAL VIEWS OF THE DRAWINGS

FIG. 1 shows a photograph including a depiction of a permission object, in accordance with an embodiment of the invention;

FIG. 2 shows a block system schematic of a photo processing system, in accordance with an embodiment of the invention;

FIG. 3 shows a block schematic of a digital camera, in accordance with an embodiment of the invention;

FIG. 4 shows a system diagram of a photo hosting web site, in accordance with an embodiment of the invention;

FIG. 5 shows a photo processing software environment, in accordance with an embodiment of the invention;

FIG. 6 shows a flow chart diagram of a method of processing a photograph file, in accordance with an embodiment of the invention;

FIG. 7 shows a flow chart diagram of a method of downloading a permission object, in accordance with an embodiment of the invention; and

FIG. 8 shows a flow chart diagram of acquiring a permission object by purchase, and registration of the permission object, in accordance with an embodiment of the invention.

### DETAILED DESCRIPTION

The present invention discloses a solution for the problem of photographic media being taken and published without consent of persons or the owners of items or views depicted in the photographic media. More specifically, the invention includes the use of a permission object, which is a physical object or representation located in proximity with the person, item or view of which photographs are to be controlled. The permission object will be visible in the photograph as a result. The permission object's presence in the photograph may be detected by pattern recognition systems using a database or library of permission objects as a reference. Once a permission object is detected in the photograph being processed, permission is then determined as to whether further processing is allowed, or if the photograph file must be destroyed or altered. The photograph processing system may be implemented in any system through which photographic media is acquired or transmitted, including digital cameras, hosting websites, email systems, photo editing software environments, and so on.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk—read only memory (CD-ROM), compact disk—read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

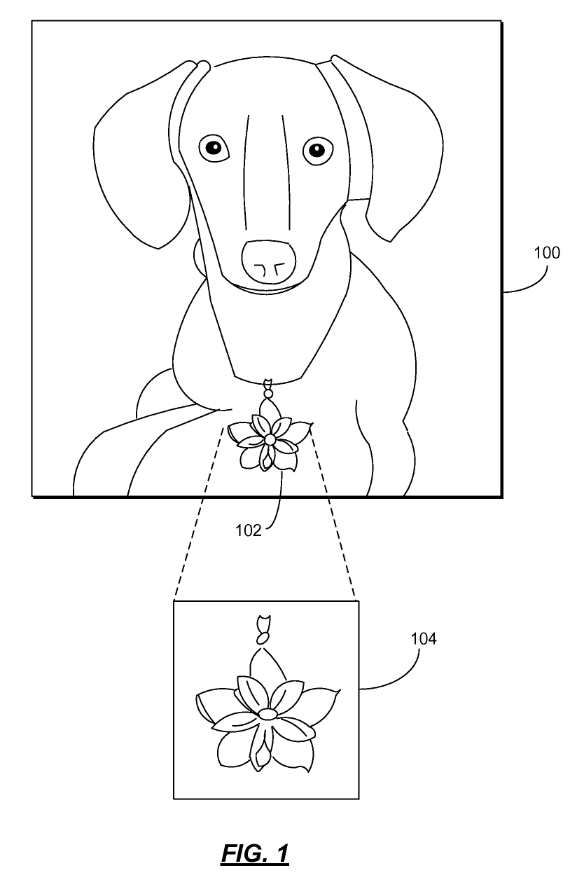

FIG. 1 shows a photograph 100 including a depiction of a permission object 102, in accordance with an embodiment of the invention. The photograph represents a digital rendering of a photograph file, produced by taking a picture using a digital camera, or scanning a photograph to produce a digital version of the photograph. The photograph of the present example depicts a dog. The owner of the dog desires to control use of photographs of the dog, particularly those taken without permission of the owner. The invention may be used to protect any person or item, so long as the permission object is in view and resolvable. To protect against unauthorized photographs or reproductions of the photograph, a permission object 102 is physically provided in proximity to the subject of protection. That is, the permission object is a physical object which is placed in physical proximity with the item or person being protected by the invention, there therefore appears in the field of view of the photograph. Upon taking the photograph, a depiction of the permission object 104 appears in the photograph. The permission object depiction is enlarged and shown by itself in 104 to more clearly show the permission object. The permission object shown is but one example of a permission object, and many varieties of shapes, patters, colors, and other variations may be used. A permission object may be unique, and registered to one person, or it may be, for example, indicative of a permission class. Furthermore a permission object may take any variety of forms, including jewelry such as pendants or brooches, patterns on apparel, hair accessories, and so on. A permission object may also be a two dimensional pattern, such as a printout of an image.

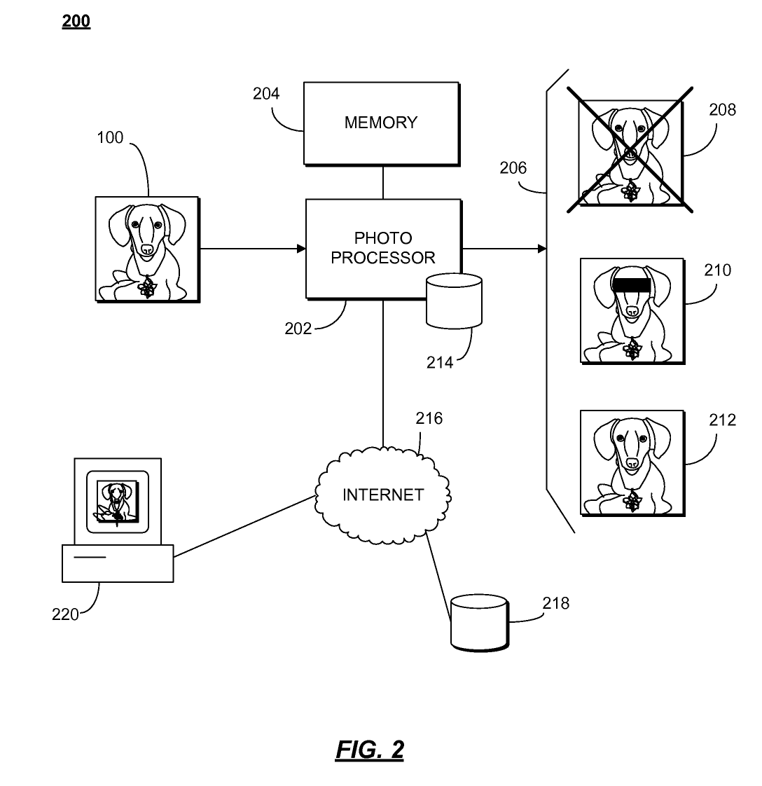

Referring now to FIG. 2, there is shown a block system schematic of a photo processing system 200, in accordance with an embodiment of the invention. A photograph file 100 is received at a photograph processor 202 of a photograph processing system. The photograph processor may be any computing platform capable of executing the invention as described herein, including a digital camera, a web media hosting server, a messaging server, a photo processing software environment or application, and so on. The photograph file may be received by acquiring the photograph with a digital camera, as a submission to a web hosting service, in a message being transmitted through a messaging server, or upon opening the photograph file with a photo processing or editing software application, among other means. The photo processor 202 includes hardware and software elements to scan the photograph file, identify or recognize permission object depictions when present, determine what limitations on processing the photograph file correspond to the permission object depicted in the photograph, and process the photograph accordingly. The photo processor may be a general purpose computing system executing software designed in accordance with invention. The photo processor may likewise be an embedded system operating according to instruction code in firmware or the like, or alternatively as part of a distributed or networked system or enterprise. Generally, the photo processor operates according to instruction code stored in a memory 204, which is a machine readable storage medium, as is well known.

The photo processor 202 is configured by instruction code to scan the photograph file 100 and detect the presence of a permission object depiction if one is sufficiently resolvable. If no such depiction is found, the photograph is considered unprotected and may be processed as such. Once a permission object is detected in the photograph the permission associated with the permission object must then be determined. Once the associated permission has been determined, the photograph file is further processed to provide one of several results 206. The permission may indicate that no further processing is allowed, and the photograph file is to be destroyed 208. Alternatively, the permission may indicate that the photograph is to be altered or a portion obscured 210. The permission may also be such that, although use of the photograph may be otherwise limited, the present processing is allowed, or no permission object has been detected 212. If the photograph is not destroyed, then the photograph file may be stored, or published on an internet hosting web site, or transmitted to a remote party, as the case may be for the present processing function.

In scanning the photograph file, a pattern recognition process is used to detect the permission object depiction. The pattern recognition process may use a local library 214 of reference pattern files, each of which may correspond to a different permission object. The pattern files may be graphically indexed to allow complex shapes and patterns to be detected easier. Furthermore, the pattern or reference files may additionally include information pertaining to the owner or registrant of the permission object. The photo processor may also access a remote library 218 over a network such as the internet 216, instead of, or in addition to the local library 214, depending on the specific application. While scanning the photograph file, the photo processor may determine the likelihood that a section of field of the photograph contains a permission object depiction. If the determined likelihood meets or exceeds some pre-determined level, the photo processor may, in one embodiment of the invention, prompt an operator to verify a match. For example, the photo processor may render the photograph file on a display along with a rendering of the reference file for the suspected permission object. The operator may then make the final determination as to whether there is a match. Alternatively, the photo processor may issue a notification message to a registrant 220 of the permission object. That is, people may obtain or purchase a permission object, and register the permission object with the photo processing system, or a permission object registry, such as external library 218. Upon receiving the notification, the registrant may confirm that the photograph contains the registrant's registered permission object, and allow the registrant to indicate whether permission is granted for further processing with a response. It is further contemplated that, after issuing the notification, if the registrant fails to respond within a preselected period of time, the photo processor may apply a default permission, such as simply destroying the photograph file.

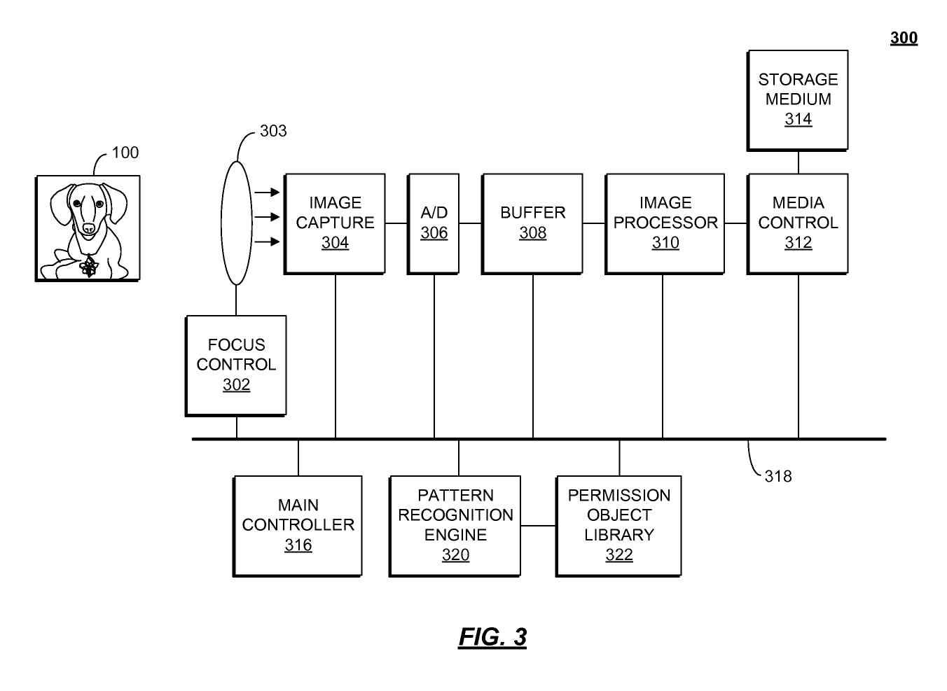

FIG. 3 shows a block schematic diagram of a digital camera 300, in accordance with an embodiment of the invention. In the camera a focus controller 302 operates an optical system 303 to focus light onto an image capture array 304, such as, for example a charge coupled device (CCD), for conversion of light to an electrical charge corresponding to brightness and color of the received light. An analog to digital converter 306 converts the electrical signals to digital form, and the digitized photograph is passed into a buffer 308. An image processor 310 processes the raw photograph by adjusting color, contrast, and so on. The image processor may also be a stopping point in the process where a pattern recognition engine 320 receives the photograph file and commences scanning the photograph file for a permission object depiction. The pattern recognition may be a physically separate component, or it may be included as a function of the image processor. Under normal operation, once the photograph is processed, it is passed to a media access controller 312, which stores the photograph in a storage medium 314. The various elements, components, and subsystems of the camera are operated under the supervision of a main controller 316, which is coupled to other elements by a bus 318. The pattern recognition engine 320 may scan photographs for permission object using reference files in a permission object library 322. The pattern recognition engine may scan a photograph after it is taken, and before it is stored in the non-volatile storage medium 314, or it may operate in a background process, scanning photograph files after they have been placed in the storage medium. Given that the permission object library is embedded, it is contemplated that the camera may only recognize a small set of generic permission objects, rather than specific ones registered to individuals. Whenever any of the permission objects are recognized in the photograph, the photograph file may be subject to deletion.

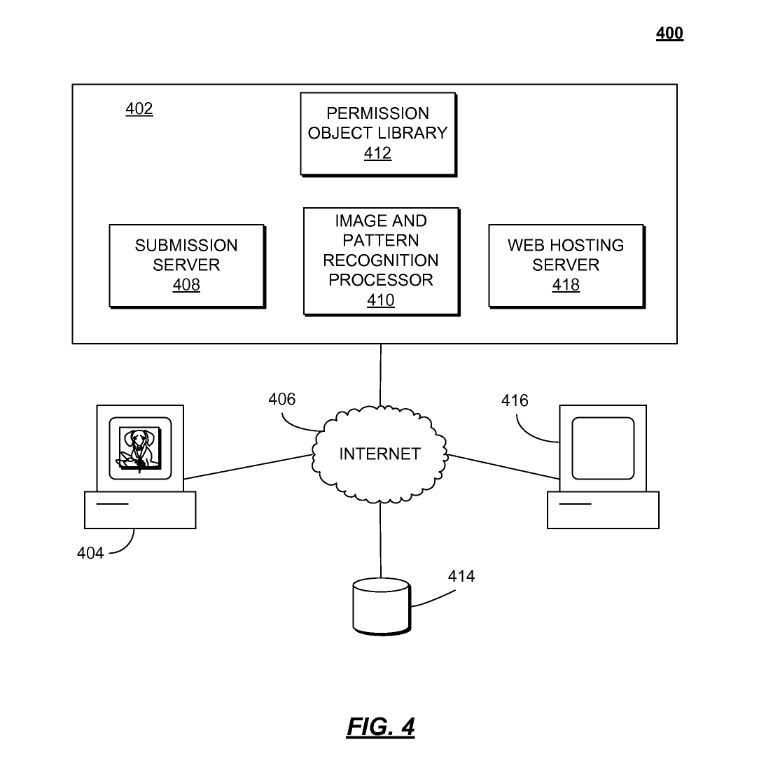

FIG. 4 shows a system diagram 400 including a photo hosting web site 402, in accordance with an embodiment of the invention. Media hosting websites have gained popularity in recent years, and will likely continue to grow in popularity, allowing individuals to publish and share pictures, video files, audio, and other media with others. Some such web sites simply make the files available on the internet, while other sites may be more elaborate and provide a social networking function. A user 404 may establish an account with the web site 402, allowing the user to upload media which is then made accessible over the internet 406 or other networks. To upload media, a client application at the user's remote terminal contacts a submission server 408 of the web site. Typically the client application is a browser which can execute applets and scripts to facilitate selection of files to upload and the actual submission. Once a photograph is received at the submission server, the image and pattern recognition processor 410 commences scanning the photograph file to determine if any permission objects can be detected in the photograph. The pattern recognition processor may use permission object reference files in a permission object library 412 which may be located with the website, such as for a back end application. A remote library 414 may also be accessed, as needed, depending on the desired implementation. If the pattern recognition processor detects the presence of a permission object depiction in a photograph or image file, the corresponding permission must be determined. The permission associated with the permission object dictates how the photograph file is to be handled. For example, if a protected photograph, meaning one which contains a permission object depiction, is submitted, the web site may simply refuse to host the photograph and delete the file. Alternatively, the web site may issue a challenge to the submitter, asking for a password, where the password may be stored with the permission object reference file in the permission object library, or encoded in the appearance or arrangement of the permission object. Another option is for the web site to temporarily store or hold the photograph file and issue a notification to a registrant 416 of the permission object, which may be a different entity than the submitter 404. The notification informs the registrant that someone is attempting to publish the photograph, and may request permission to proceed, or invite a response if the registrant does not desire to have the photograph published. The notification may include a copy of the photograph, or a portion of the photograph containing the permission object depiction for verification by the registrant. If a response is not received within a preselected period of time, a default permission may be applied to the photograph. Upon determining that the photograph may be published, as indicated by the permission indicated in the reference file, or by a successful response to a challenge issued to the submitter, or by a response from the registrant of the permission object, the photograph may then be stored in association with a web hosting server 418 which makes the photograph available.

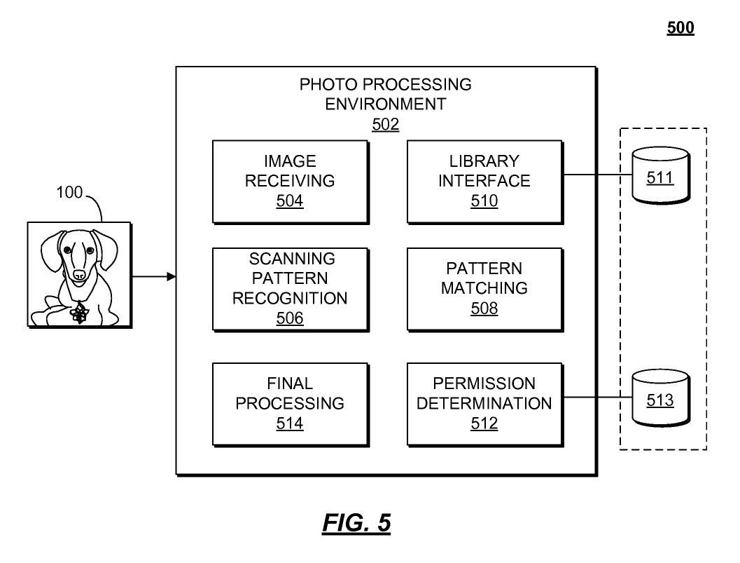

FIG. 5 shows a photo processing system 500 including a photo processing software environment 502, in accordance with an embodiment of the invention. The photo processing environment results from instantiating a software application on a computing platform, such as, for example, a general purpose or personal computer, as a back end application coupled to a web server, a messaging server, on a node in a distributed computing environment, and so on. In one embodiment the photo processing environment is produced by use of a computer program product for photographic image processing, which may be stored on a machine readable storage medium and contains machine or instruction code which is executed by the photograph image processing system. The code is instantiated in an execution environment and includes code 504 which configures the photographic image processing system to receive an image 100. Upon receiving the photograph, scanning pattern recognition code 506 configures the system to scan the photograph file for a permission object depiction. The scanning is facilitated by pattern matching instruction code 508 which may access a reference pattern library 511 via a library interface 510. Alternatively it is contemplated that the pattern matching may simply determine a likelihood of a match, and if the likelihood is sufficiently high, the system may prompt an operator to examine the photograph and rendered reference file for comparison to make a final determination as to whether there is a match. Once a permission object is detected in the photograph, the system must then determine the permission associated with the permission object, as facilitated by permission determination code 512. The permission determination code may configure the system to a access permission object reference library 511 to locate permission information associated with the reference file corresponding to the detected permission object, or, a different library 513 may be accessed. Libraries 511 and 513 may be merged, or separate, as indicated by the dashed line box around them. Furthermore, the permission determination code may issue a notification to a registrant of the permission object, as described in reference to FIGS. 3 and 4.

Once the permission has been determined, the final possessing code 514 may then take the final action. For example, if the permission does not allow the requested use, the system may simply delete the photograph. If the photo processing environment is part of a photo editing application, the requested or attempted editing may be disabled, preventing a user of the photo editing software from altering the photograph as would be desirable to prevent removal of the permission object depiction from the photograph. If permission is such that further use of the photograph is permitted, then whatever requested action was initially undertaken may then be commenced, including publishing the photograph, allowing it to pass as an attachment to a message, storing it in memory, and so on.

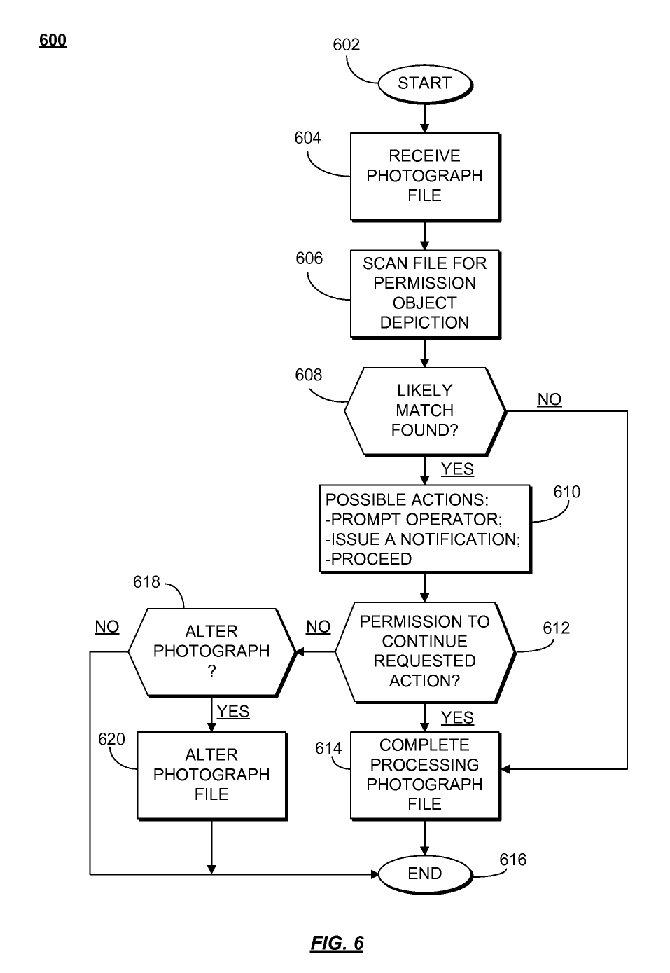

FIG. 6 shows a flow chart diagram 600 of a method of processing a photograph file, in accordance with an embodiment of the invention. The method may be implemented in any system or device which handles, transmits, publishes, modifies, or acquires photographic media. At the start 602, the system implementing the method is ready to begin processing or otherwise handling photographic media. Accordingly, the method commences upon receiving a photograph file (604). The photograph file may be received by acquiring a photographic image at a camera, as a submission to a web hosting site, as a file opened by a photo editing software application, as an attachment in a message, and so on. Upon receiving the photograph file, the method then commences scanning the photograph file for any permission object depictions (606) that may be present, which generally includes conventional pattern recognition techniques, using a reference library of reference files corresponding to known permission objects. If a sufficiently likely match is found (608), one of several actions may be taken, including prompting an operator of the system to examine the rendered photograph and compare it to one or more suspected permission objects to make a final determination as to whether the photograph contains a permission object depiction. If the match likelihood is sufficiently high, then the system may simply obtain the permission information from the reference file corresponding to the permission object. Alternatively, the system may issue a notification to a registrant associated with the permission object to elicit a response indicating whether the requested processing may be further commenced. Likewise, the system may issue an authentication or password challenge to the requesting user, to which a successful response password which matches a reference password used by the photograph processing system would indicate that the requesting user is the registrant, and permission is therefore granted implicitly. Alternatively, the permissions information may indicate which actions are allowed, and if the requested action is a permitted action, then the system may simply proceed with the requested action. Accordingly, if the permission, as determined by the system, indicates further processing may be commenced (612), the system then finishes the requested processing (614) and the method terminates (616). If, upon scanning the photograph and no permission object depiction are found (608), then the method may commence with the requested action and complete processing of the photograph file (614), and subsequently terminate the method for the present photograph file. In some cases it is contemplated that permission to proceed at 612 may be conditioned upon taking some further action such as altering the photograph (618), such as by blocking out a portion of the photograph (620). For example, a simple facial recognition process may be used to locate a face in proximity to the permission object in the photograph, and then to obscure the face. Alternatively, the permission may allow alteration of the photograph, except for a region of the photograph containing the permission object depiction, in order to defeat attempts to remove the permission object from the photograph. If the permission in 612 did not allow the requested action, or if the photograph is not to be altered in the present embodiment, the method terminates from 618, deleting or destroying the photograph file.

It will be appreciated by those skilled in the art that the particular processes of the method illustrated in FIG. 6 may be performed differently or in different order in some cases. For example, in one alternative embodiment, a user of a photo editing software application may be allowed to edit the photograph and have changes rendered without regard for the presence of a permission object depiction in the photograph, however the user would not be allowed to save or print the edited photograph if the permission corresponding to the permission object prohibits such action.

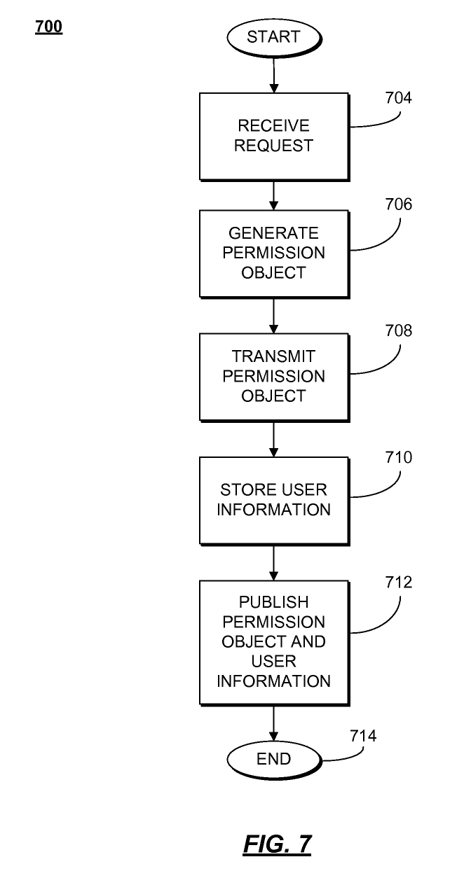

FIG. 7 shows a flow chart diagram 700 of a method of downloading a permission object, in accordance with an embodiment of the invention. A person interested in protecting their likeness or the likeness of someone else or some item or object may acquire a permission object with the present method. The method allows a person to obtain a digital permission object file which may be rendered as an image and printed, thereby providing a physical realization of the permission object. The present method is facilitated by a web site which is designed to receive and fulfill requests for permission object files. Accordingly, the website first receives a request (704) for a permission object. The receiving system may then generate a permission object (706), or it may have a cache of previously generated permission objects to assign to the requesting entity. Once the permission object is selected or generated at the system, the system then transmits the permission object to the requesting party (708). The permission object may be transmitted as a file containing a digital image of the permission object which can be printed. Upon printing the permission object it may be attached to an item which the requesting person desires to protect. In addition to generating or otherwise assigning a permission object to the requesting user, the system also generates a user file to be associated with the assigned permission object; the file may include, for example, an email address, and a password for permission challenges, in addition to reference information regarding the permission object. This information may then be stored (710) on a permission object reference server, and it may additionally be published (712) to other such servers and information databases for use in practicing the invention. Once the information is properly stored and made available the method terminates (714).

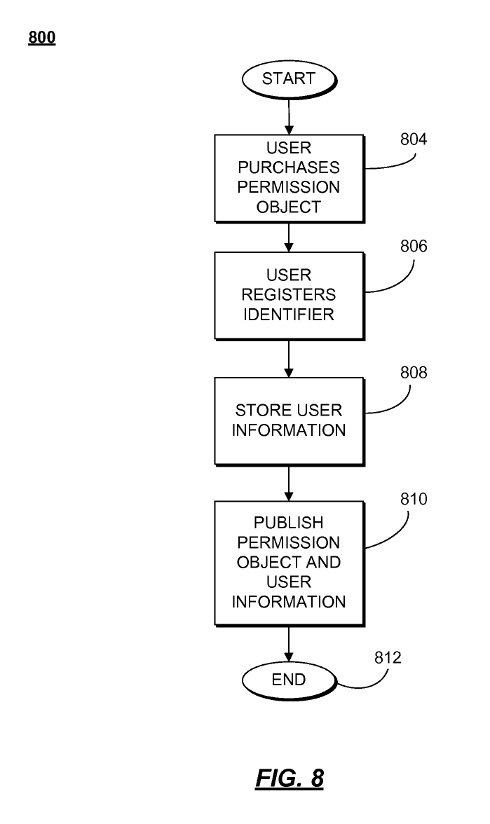

In addition to downloading a digital permission object, it is contemplated that one may wish to use a physical object, rather than a print out. FIG. 8 shows a flow chart diagram 800 of a method of acquiring a permission object by purchase, and registration of the permission object, in accordance with an embodiment of the invention. Permission objects may be purchased through a variety of channels, including both conventional stores, online mail order websites, and so on. The method commences upon a user purchasing a permission object (804). The user may peruse a selection of permission objects, which may be provided in the form of jewelry or as designs on apparel, among other forms. In one embodiment of the invention any permission object has a default “not allowed” permission and only needs to be worn or placed in proximity with the person or item being protected from unauthorized photographs. Any number of object patterns or configurations may be used, with each pattern and configuration being catalogued. The user/purchaser needs to take no further action since the permission object will be already referenced. Alternatively, one may desire more control, and notifications when their permission object is detected by a photograph processing system. Accordingly, each permission object may be configured in a unique pattern, and associated with a serial number or other unique identifier. Upon purchasing the permission object the user then registers the permission object (806). Registering the permission object may include providing certain personal and contact information to a permission object registry. For example, a registrant my provide an email address at which the registrant desires to receive notifications from photograph processing systems in the event that the registrant's permission object is detected in a photograph being processed by the photograph processing system. The user may also indicate default a permission to be used by photograph processing systems which do not issue notifications requesting permission. Additionally, the registrant may provide a password to be used in responding to authentication challenges issued by photograph processing systems upon detecting the registrant's permission object, such as when the registrant is processing their own photographs and to prevent unauthorized parties from using photographs including a depiction of the registrant's permission object. Registering the permission object may be performed in a variety of ways, including at the time of purchase, via a website subsequent to purchase, by a mail-in card, and so on. Any suitable way to get information to the registry is suitable. Once the registry receives the registrant's information, and deems it sufficiently authentic, the registry may then store the registrant's information (808) with the identifying information of the permission object. The registrant's information is then associated with the permission object in the permission object registry. The registry may be the only location where the registrant information is kept, but it is contemplated that the registry may publish the information (810) to other registries and permission object reference libraries used by a variety of photograph processing systems. The method terminates (812) when no further action is necessary.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of controlling use of photographic media, comprising:
receiving a photograph file;
scanning the photograph file for a permission object depiction, wherein the permission object depiction corresponds to a permission object visible in the photograph file when the photograph file is visually rendered;
detecting the permission object depiction in the photograph file as a result of scanning the photograph file; and
determining a permission corresponding to the permission object, wherein the permission indicates whether further processing of the photograph file is permitted.

2. A method of controlling use of photographic media as defined in claim 1, wherein receiving the photograph file comprises capturing the photograph file with a digital camera.

3. A method of controlling use of photographic media as defined in claim 2, wherein the camera further performs processing the photograph file, detecting the permission object depiction, and determining the permission, wherein the permission indicates whether the camera is allowed to store the photograph file.

4. A method of controlling use of photographic media as defined in claim 1, wherein receiving the photograph file comprises receiving the photograph file at a photograph hosting web site.

5. A method of controlling use of photographic media as defined in claim 4, wherein the web site further performs processing the photograph file, detecting the permission object depiction, and determining the permission, wherein the permission indicates whether the web site is allowed to host the photograph file.

6. A method of controlling use of photographic media as defined in claim 1, further comprising:
upon detecting the permission object depiction, determining a registrant entity associated with the permission object; and
issuing a notification to the registrant entity that the photograph file has been received and contains the permission object depiction.

7. A method of controlling use of photographic media as defined by claim 6, wherein determining the permission comprises prompting the registrant entity in the notification to confirm the permission object depiction and indicate whether further use of the photograph file is permitted.

8. A method of controlling use of photographic media as defined by claim 1, wherein determining the permission comprises:
issuing a password challenge to a party from whom the photograph file is received; and
successfully receiving a correct password from the party.

9. A method of controlling use of photographic media as defined by claim 8, wherein successfully receiving the correct password is performed by comparing a received password with a password reference stored in a reference file used for detecting the permission object.

10. A method of processing photographic media depicting a permission object, comprising:
scanning a photograph file for a permission object depiction, wherein the permission object depiction is the result of a permission object being in a field of view of the photograph file;
detecting the permission object depiction in the photograph file as a result of scanning the image file;
determining a permission corresponding to the permission object; and
processing the photograph file according to the permission corresponding to the permission object.

11. A method of processing photographic media as defined in claim 10, wherein detecting the permission object depiction comprises detecting a pattern in the photograph file substantially corresponding with a stored representation of the permission object.

12. A method of processing photographic media as defined in claim 11, wherein detecting the permission object depiction comprises prompting an operator for confirmation that the permission object depiction corresponds with a stored representation of the permission object.

13. A method of processing photographic media as defined in claim 10, wherein determining the permission comprises:
issuing a notification to a registrant entity associated with the permission object; and
receiving a response from the registrant entity indicating the permission, or receiving no response from the registrant entity within a pre-selected period of time and applying a default permission.

14. A method of processing photographic media as defined by claim 10, wherein determining the permission comprises:
issuing a password challenge to a party from whom the photograph file is received; and
successfully receiving a correct password from the party.

15. A method of processing photographic media as defined in claim 10, wherein processing the photograph file comprises hosting the photograph file on a web site.

16. A method of processing photographic media as defined in claim 10, wherein processing the photograph file comprises altering the photograph file.

17. A method of processing photographic media as defined in claim 16, wherein altering the photograph file comprises obscuring a portion of the photograph file.

18. A method of processing photographic media as defined in claim 16, wherein processing the photograph file comprises destroying the photograph file.

19. A computer program product for photographic image processing, comprising:
a machine readable storage medium;
machine code stored in the machine readable storage medium which when executed by a photograph image processing system configures the photograph image processing system to:
scan a photograph file for a permission object depiction, wherein the permission object depiction is the result of a permission object being in a field of view of the photograph file;
detect the permission object depiction in the photograph file as a result of scanning the image file;
determine a permission corresponding to the permission object; and
process the photograph file according to the permission corresponding to the permission object.

20. A computer program product as defined in claim 19, wherein the machine code that configures the image processing system to detect the permission object depiction further configures the image processing system to prompt an operator for confirmation that the permission object depiction corresponds with a stored representation of the permission object.

21. A computer program product as defined in claim 19, wherein the machine code that configures the image processing system to determine the permission further configures the image processing system to:
issue a notification to a registrant entity associated with the permission object; and
receive a response from the registrant entity indicating the permission, or receive no response from the registrant entity within a pre-selected period of time and apply a default permission.

22. A computer program product as defined in claim 19, wherein the machine code that configures the image processing system to determine the permission further configures the image processing system to:
issue a password challenge to a party from whom the photograph file is received; and
receive a password response from the party;
wherein the password response matches a reference password.

23. A computer program product as defined in claim 19, wherein the machine code that configures the image processing system to process the photograph file further configures the image processing system to host the photograph file on a web site.

24. A computer program product as defined in claim 19, wherein the machine code that configures the image processing system to process the photograph file further configures the image processing system to destroy the photograph file if the permission indicates that no further processing is permitted.
